(19) United States
(12) Patent Application Publication
(10) Pub. No.: US 2013/0016738 A1
(43) Pub. Date: Jan. 17, 2013

(54) METHOD AND APPARATUS FOR IMPLEMENTING FRAME HEADER ALIGNMENT AND MULTI-FRAME ZEROING

(71) Applicants: Shide Yu, Shenzhen (CN); Wenkai Ma, Shenzhen (CN)

(72) Inventors: Shide Yu, Shenzhen (CN); Wenkai Ma, Shenzhen (CN)

(73) Assignee: ZTE Coration, Shenzhen ,Guangdong Province (CN)

(21) Appl. No.: 13/634,847

(22) PCT Filed: Oct. 15, 2010
(86) PCT No.: PCT/CN2010/077787

§ 371 Date: Sep. 13, 2012

(30) Foreign Application Priority Data
Mar. 16, 2010 (CN) 201010132327.6

(51) Int. Cl. H04J 3/06

(52) U.S. Cl. 370/503

(57) ABSTRACT

The present invention discloses a method for implementing frame header alignment and multi-frame zeroing. By using one indication signal, the period of which is 256 times of that of a single frame, the frame header alignment for frame data is completed, and the multi-frame zeroing for frame data is implemented. The present invention also discloses an apparatus for implementing frame header alignment and multi-frame zeroing. The implementation process of the present invention is simple, the process comprising the frame data processing in an Optical Transport Network (OTN) cross dispatching system can be effectively simplified, the complexity of system processing can be significantly decreased, and the logical resources of the system can be saved.

### FIELD OF THE INVENTION

The present invention relates to the field of an Optical Transport Network (OTN), in particular to a method and an apparatus for implementing frame header alignment and multi-frame zeroing.

### BACKGROUND OF THE INVENTION

As a core technology of a new generation bearer network, an OTN can realize transparent transmission and cross dispatching of large granularity service flows and has been widely applied. The cross dispatching of customer service flows is an important function of an OTN system. When an existing OTN cross dispatching system performs cross dispatching, frame header alignment and multi-frame zeroing for frame data are required.

In the prior art, during the cross dispatching or other frame data processing, one reference frame header indication signal is used to complete the frame header alignment for a plurality of paths of OTN frame data, and one multi-frame zeroing indication signal is then used to complete the multi-frame zeroing for a plurality of paths of OTN frame data. The reference frame header indication signal and the multi-frame zeroing indication signal have to be generated respectively due to different periods, as a result, the process is complex when the OTN cross dispatching system or other OTN frame processing system completes frame header alignment and multi-frame zeroing, the working efficiency of the system is influenced, and the logic resources of the system are wasted.

### SUMMARY OF THE INVENTION

In view of the above, the present invention provides a method and an apparatus for implementing frame header alignment and multi-frame zeroing, which solve the problems of low working efficiency of the OTN frame processing system and wasted system resources in the existing technology caused by the complex frame header alignment and multi-frame zeroing process.

The technical solution of the present invention is implemented as follows.

The present invention provides a method for implementing frame header alignment and multi-frame zeroing, comprising: generating an indication signal, a period of which is 256 times of that of a single frame; and according to the indication signal, performing frame header alignment for a plurality of paths of input frame data and then outputting the frame data, and performing multi-frame zeroing for the plurality of paths of input frame data and then outputting the frame data.

Preferably, in the solution, a process of performing the frame header alignment comprises: performing frame header alignment once each time 256 frames of data are input.

Preferably, in the solution, a process of performing frame header alignment once comprises: performing frame header positioning for the plurality of paths of input frame data; from positioned frame header position of each path of frame data, respectively writing data of each frame into a cache, after detecting an arrival of a high level of the indication signal, simultaneously reading each path of frame data from an initial position of the cache.

Preferably, in the solution, a process of performing frame header alignment once comprises: according to deviations between the plurality of paths of input frame data and the indication signal in terms of frame header, delaying the indication signal; according to the delayed indication signal, performing frame header alignment for the plurality of paths of input frame data.

Preferably, in the solution, when the indication signal is delayed, a delay period of the indication signal is determined by a deviation value between a frame header of the indication signal and a frame header of frame data to be performed with the frame header alignment.

Preferably, in the solution, a process of performing the multi-frame zeroing comprises: performing multi-frame zeroing once each time 256 frames of data are input.

Preferably, in the solution, a process of performing multi-frame zeroing once comprises: when a high level of the indication signal arrives, zeroing a multi-frame of one or more paths of frame data input at this moment, obtaining a multi-frame of frame data input in turn latter by accumulating 1 to a multi-frame of an immediately previous frame data and outputting the frame data; until the high level of the indication signal arrives again, zeroing the multi-frame of one or more paths of frame data input at this moment.

The present invention also provides an apparatus for implementing frame header alignment and multi-frame zeroing, comprising: an indication signal generation unit, a frame header alignment unit and a multi-frame zeroing unit, wherein the indication signal generation unit is configured to generate an indication signal, a period of which is 256 times of that of a single frame; the frame header alignment unit is configured to, according to the indication signal generated by the indication signal generation unit, perform frame header alignment for a plurality of paths of input frame data and then output the frame data; and the multi-frame zeroing unit is configured to, according to the indication signal generated by the indication signal generation unit, perform multi-frame zeroing for the plurality of paths of input frame data and then output the frame data.

Preferably, in the solution, the frame header alignment unit is further configured to, according to deviations between the plurality of paths of input frame data and the indication signal in terms of frame header, delay the indication signal.

In the present invention, by using one indication signal, the period of which is 256 times of that of a single frame, the frame header alignment for frame data is completed, and the multi-frame zeroing for frame data is implemented. The implementation process of the present invention is simple, the process comprising frame data processing in the OTN cross dispatching system can be effectively simplified, the complexity of system processing can be significantly decreased, the working efficiency of the system can be greatly improved, and the logical resources of the system can be saved.

### BRIEF DESCRIPTION OF THE DRAWINGS

FIG. 1 is a flow diagram of a method for implementing frame header alignment and multi-frame zeroing in an embodiment of the present invention;

FIG. 2 is a composition and structure diagram of an apparatus for implementing frame header alignment and multi-frame zeroing in an embodiment of the present invention;

FIG. 3 is a pulse diagram of an indication signal in an embodiment of the present invention;

FIG. 4 is a composition and structure diagram of an OTN cross dispatching system;

FIG. 5 is a flow chart of implementing a cross dispatching process by using the method in the embodiment of the present invention.

### DETAILED DESCRIPTION OF THE EMBODIMENTS

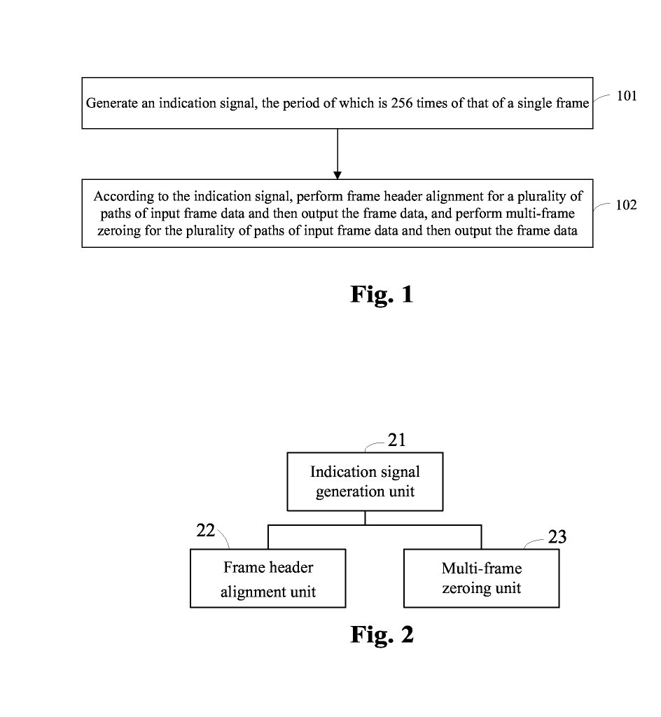

With reference to FIG. 1, the method for implementing frame header alignment and multi-frame zeroing in an embodiment of the present invention mainly comprises the following steps:

Step 101: an indication signal, the period of which is 256 times of that of a single frame, is generated;

Step 102: according to the indication signal, frame header alignment is performed for a plurality of paths of input frame data and then the frame data are output, and multi-frame zeroing is performed for the plurality of paths of input frame data and then the frame data are output.

To implement the method, an embodiment of the present invention also provides an apparatus for implementing frame header alignment and multi-frame zeroing. With reference to FIG. 2, the apparatus mainly comprises: an indication signal generation unit 21, a frame header alignment unit 22 and a multi-frame zeroing unit 23, wherein the indication signal generation unit 21 is configured to generate an indication signal, the period of which is 256 times of that of a single frame; the frame header alignment unit 22 is configured to, according to the indication signal generated by the indication signal generation unit 21, perform frame header alignment for a plurality of paths of input frame data and then output the frame data; the multi-frame zeroing unit 23 is configured to, according to the indication signal generated by the indication signal generation unit 21, perform multi-frame zeroing for the plurality of paths of input frame data and then output the frame data.

Herein, the period of the generated indication signal is 256 times of that of a single frame, so that the multi-frame overhead of the OTN frame data can be zeroed once every 256 frames. The single frame can be an Optical channel Date Unit K (ODU_K) (K=1, 2, 3) single frame.

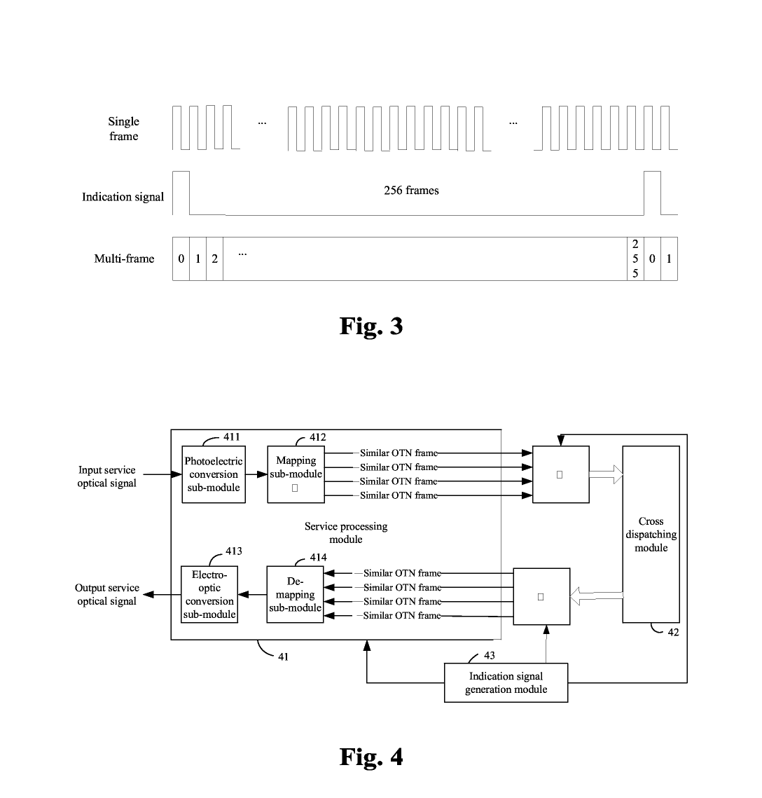

Specifically, as shown in FIG. 3, the indication signal generated by the indication signal generation unit 21 is specifically as follows: the indication signal, the period of which is 256 times of the ODUK frame period, wherein one high level is generated every 256 ODUk frame periods.

The indication signal generation unit 21 respectively outputs the indication signal to the frame header alignment unit 22 and the multi-frame zeroing unit 23, and the frame header alignment unit 22 and the multi-frame zeroing unit 23 respectively perform frame header alignment and multi-frame zeroing according to the indication signal.

The frame header alignment unit 22 first performs frame header positioning for a plurality of paths of frame data input to the frame header alignment unit 22, and then writes the frame data into a cache from the positioned frame header position of each path of frame data. After detecting an arrival of a high level of the indication signal generated by the indication signal generation unit 21, the frame header alignment unit 22 simultaneously reads each path of frame data from an initial position of the cache, to complete one frame header alignment for a plurality of paths of data. Herein, as the indication signal outputs one high level each time 256 frames of data are input, the frame header alignment unit 22 also will detect one high level of the indication signal each time 256 frames of data are input, so that it performs frame header alignment once each time 256 frames of data are input.

If the deviations between the indication signal and a plurality of paths of frame data input to the frame header alignment unit 22 in terms of frame header, it is required to delay the indication signal, and then the frame header alignment is performed for the plurality of paths of input frame data according to the delayed indication signal.

Herein, when the indication signal is delayed, a delay period of the indication signal is determined by a deviation value between a frame header of the indication signal and a frame header of the frame data to be performed with frame header alignment. Generally, one frame of data can be optionally selected from a plurality of paths of frame data to be performed with frame header alignment, the deviation value between the frame header of the frame data and the frame header of the indication signal is determined, and the deviation value is used as the delay period of the indication signal.

When detecting that the high level of the indication signal from the indication signal generation unit 21 arrives, the multi-frame zeroing unit 23 zeros the multi-frame of one or more paths of frame data input thereto at this moment and then outputs the frame data, obtains the multi-frame of frame data input in turn latter by accumulating 1 to the multi-frame of the immediately previous frame data and outputs the frame data, until the high level of the indication signal arrives again when there are 255 multi-frames of the input frame data, zeros the multi-frame of frame data input at this moment. In this way, the multi-frame zeroing unit 23 performs multi-frame zeroing once each time 256 frames of data are input. The above process is repeated again and again, to complete the multi-frame zeroing for a plurality of paths of frame data. Multi-frames are shown in FIG. 3.

The apparatus and the method provided in the embodiments of the present invention will be applied in an OTN cross dispatching system, with the following specific implementation.

As shown in FIG. 4, the OTN cross dispatching system mainly comprises: a service processing module 41, a cross dispatching module 42 and an indication signal generation module 43, wherein the service processing module 41 comprises a photoelectric conversion sub-module 411, a mapping sub-module 412, an electro-optic conversion sub-module 413 and a de-mapping sub-module 414.

The main processing process of the OTN cross dispatching system is described as follows. First, an input service optical signal is fed into the photoelectric conversion sub-module 411 and then photo-electrically converted into a service data electrical signal. The service data electrical signal is mapped and encapsulated to a similar OTN frame data by the mapping sub-module 412. Then, the similar OTN frame data obtained by mapping is fed into the cross dispatching module 42 to be crossly dispatched. Afterwards, the crossly dispatched similar OTN frame data is then transmitted to the de-mapping sub-module 414 to be de-mapped and converted into a service data electrical signal in a standard service frame format. Finally, the service data electrical signal is electro-optically converted by the electro-optic conversion sub-module 413 into a service optical signal to be output.

Herein, the similar OTN frame is a frame format with a fixed rate level. Similar to an OTN frame, the similar OTN frame is fixed in length and is used for encapsulating service data electrical signals with different rate levels.

During the processing of the OTN cross dispatching system, it is required to perform the frame header alignment twice and the multi-frame zeroing once according to the indication signal generated by the indication signal generation module 43. The two frame header alignments are respectively performed before and after the cross dispatching; while the multi-frame zeroing is required to be performed when the source-end processing sub-module 411 completes mapping of the service data electrical signal, to count the multi-frame overhead in the similar OTN frame data, and to complete the generation of multi-frame bytes in the OTN frame data.

For the OTN cross dispatching system, before applying the method in the embodiment of the present invention in the cross dispatching process thereof, as shown in FIG. 4, it is required to set the indication signal generation unit in the apparatus in the embodiment of the present invention into the indication signal generation module 43 in FIG. 4 or replace the indication signal generation module 43 in FIG. 4 with the indication signal generation unit, and set the multi-frame zeroing unit in the mapping sub-module 412, as shown by \hat{1} in FIG. 4, and set the frame header alignment unit both at the input end and the output end of the cross dispatching module 42, as shown by \hat{2} and \hat{3} in FIG. 4.

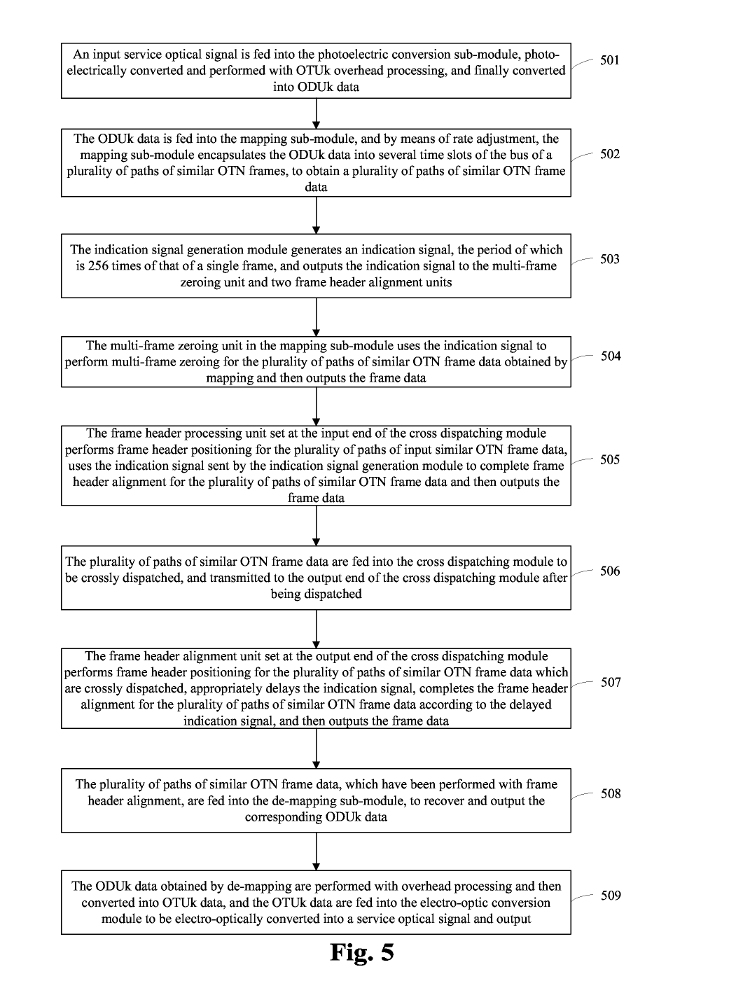

Latter, with reference to FIG. 5, the specific flow of completing cross dispatching via the system as shown in FIG. 4 is as follows.

Step 501: An input service optical signal is fed into the photoelectric conversion sub-module 411, photo-electrically converted and performed with OTUk (k=1, 2, 3) overhead processing, and finally converted into ODUk data.

Step 502: The ODUk data are fed into the mapping sub-module 412, and by means of rate adjustment, the mapping sub-module 412 encapsulates the ODUk data into several time slots of the bus of a plurality of paths of similar OTN frames, to obtain a plurality of paths of similar OTN frame data.

Step 503: The indication signal generation module 43 generates an indication signal, the period of which is 256 times of that of a single frame, and outputs the indication signal to the multi-frame zeroing unit at \hat{1} and two frame header alignment units at \hat{2} and \hat{3} in FIG. 4.

Step 504: As shown by \hat{1} in FIG. 4, the multi-frame zeroing unit in the mapping sub-module 412 uses the indication signal to perform multi-frame zeroing for the plurality of paths of similar OTN frame data obtained by mapping and then outputs the frame data.

Herein, the specific process that the multi-frame zeroing unit completes multi-frame zeroing for various paths of similar OTN frame data has been described in details, which will not be described again.

Step 505: The output similar OTN frame data, which have been performed with multi-frame zeroing, are transmitted to the input end (as shown by \hat{2} in FIG. 4) of the cross dispatching module 42, the frame header processing unit set at the input end of the cross dispatching module 42 performs frame header positioning for the plurality of paths of input similar OTN frame data, uses the indication signal sent by the indication signal generation module 43 to complete frame header alignment for the plurality of paths of similar OTN frame data and then outputs the frame data.

Herein, the specific process of frame header alignment has been described in details, which will not be described again.

Step 506: The plurality of paths of similar OTN frame data, which have been performed with frame header alignment, are fed into the cross dispatching module 42 to be crossly dispatched, and transmitted to the output end of the cross dispatching module 42 after being dispatched.

Step 507: As shown by \hat{3} in FIG. 4, the frame header alignment unit set at the output end of the cross dispatching module 42 performs frame header positioning for the plurality of paths of similar OTN frame data which have been crossly dispatched, appropriately delays the indication signal, completes the frame header alignment for the plurality of paths of input similar OTN frame data according to the delayed indication signal, and then outputs the frame data.

Herein, due to cross dispatching or other processing, the deviations between the plurality of paths of similar OTN frame data and the indication signal in terms of frame header are relatively large, during the frame header alignment after cross dispatching, it is usually required to delay the indication signal first and then perform the frame header alignment.

Step 508: The plurality of paths of similar OTN frame data, which have been performed with frame header alignment, are fed into the de-mapping sub-module 413, to recover and output the corresponding ODUk data.

Step 509: The ODUk data obtained by de-mapping are performed with overhead processing and then converted into OTUk data, and the OTUk data are fed into the electro-optic conversion module 414 to be electro-optically converted into a service optical signal and output, so far, the cross dispatching of the service optical signal in the OTN has been completed.

Above contents are only preferable embodiments of the present invention and are not used for limiting the present invention. Any modifications, equivalent replacements and improvements within the principle of the present invention should be contained within the protection scope of the present invention.

What is claimed is:

1. A method for implementing frame header alignment and multi-frame zeroing, comprising:
generating an indication signal, a period of which is 256 times of that of a single frame; and
according to the indication signal, performing frame header alignment for a plurality of paths of input frame data and then outputting the frame data, and performing multi-frame zeroing for the plurality of paths of input frame data and then outputting the frame data.

2. The method for implementing frame header alignment and multi-frame zeroing according to claim 1, wherein a process of performing the frame header alignment comprises: performing frame header alignment once each time 256 frames of data are input.

3. The method for implementing frame header alignment and multi-frame zeroing according to claim 2, wherein a process of performing frame header alignment once comprises:
performing frame header positioning for the plurality of paths of input frame data;
from positioned frame header position of each path of frame data, respectively writing data of each frame into a cache, after detecting an arrival of a high level of the indication signal, simultaneously reading each path of frame data from an initial position of the cache.

4. The method for implementing frame header alignment and multi-frame zeroing according to claim 2, wherein a process of performing frame header alignment once comprises:
according to deviations between the plurality of paths of input frame data and the indication signal in terms of frame header, delaying the indication signal; according to the delayed indication signal, performing frame header alignment for the plurality of paths of input frame data.

5. The method for implementing frame header alignment and multi-frame zeroing according to claim 4, wherein when the indication signal is delayed, a delay period of the indication signal is determined by a deviation value between a frame header of the indication signal and a frame header of frame data to be performed with the frame header alignment.

6. The method for implementing frame header alignment and multi-frame zeroing according to claim 1, wherein a process of performing the multi-frame zeroing comprises: performing multi-frame zeroing once each time 256 frames of data are input.

7. The method for implementing frame header alignment and multi-frame zeroing according to claim 6, wherein a process of performing multi-frame zeroing once comprises:
when a high level of the indication signal arrives, zeroing a multi-frame of one or more paths of frame data input at this moment, obtaining a multi-frame of frame data input in turn latter by accumulating 1 to a multi-frame of an immediately previous frame data and outputting the frame data; until the high level of the indication signal arrives again, zeroing the multi-frame of one or more paths of frame data input at this moment.

8. An apparatus for implementing frame header alignment and multi-frame zeroing, comprising: an indication signal generation unit, a frame header alignment unit and a multi-frame zeroing unit, wherein
the indication signal generation unit is configured to generate an indication signal, a period of which is 256 times of that of a single frame;
the frame header alignment unit is configured to, according to the indication signal generated by the indication signal generation unit, perform frame header alignment for a plurality of paths of input frame data and then output the frame data; and
the multi-frame zeroing unit is configured to, according to the indication signal generated by the indication signal generation unit, perform multi-frame zeroing for the plurality of paths of input frame data and then output the frame data.

9. The apparatus for implementing frame header alignment and multi-frame zeroing according to claim 8, wherein the frame header alignment unit is further configured to, according to deviations between the plurality of paths of input frame data and the indication signal in terms of frame header, delay the indication signal.
